(19) United States
(12) Patent Application Publication
(10) Pub. No.: US 2021/0241948 A1
(43) Pub. Date: Aug. 5, 2021

(54) RARE-EARTH COBALT PERMANENT MAGNET, MANUFACTURING METHOD THEREFOR, AND DEVICE

(71) Applicant: TOKIN Corporation, Sendai-shi (JP)

(72) Inventors: Hirokazu MAKUTA, Sendai-shi (JP); Hiroaki MACHIDA, Sendai-shi (JP); Teruhiko FUJIWARA, Sendai-shi (JP); Yu KANAMORI, Sendai-shi (JP)

(21) Appl. No.: 17/146,269

(22) Filed: Jan. 11, 2021

(30) Foreign Application Priority Data
Jan. 31, 2020 (JP) 2020-015379
Nov. 4, 2020 (JP) 2020-184478

(51) Int. Cl. H01F 1/055; H01F 7/02

(52) U.S. Cl. CPC H01F 1/0557; H01F 7/021

(57) ABSTRACT

A rare-earth cobalt permanent magnet having excellent magnetic characteristics, a method for manufacturing such a rare-earth cobalt permanent magnet, and a device are provided. A rare-earth cobalt permanent magnet consists of, when a rear-earth element including at least Sm is represented by R, 23 to 27 mass % of R, 1.0 to 5.0 mass % of Cu, 18 to 25 mass % of Fe, 1.5 to 3.0 mass % of Zr, and a remainder consisting of Co and unavoidable impurities, in which the rare-earth cobalt permanent magnet includes a plurality of crystal grains and grain boundary parts, and a concentration of Cu is at least two times a concentration of Zr in the grain boundary parts.

### CROSS REFERENCE TO RELATED APPLICATIONS

The present application claims priority to Japanese Patent Application No. 2020-015379, filed on Jan. 31, 2020, and Japanese Patent Application No. 2020-184478, filed on Nov. 4, 2020. The entire contents of the above-listed applications are hereby incorporated by reference for all purposes.

### BACKGROUND

The present disclosure relates to a rare-earth cobalt permanent magnet that can be applied to a variable field motor, a method for manufacturing such a rare-earth cobalt permanent magnet, and a device.

Variable field motors are attracting attention in view of their abilities to reduce energy consumed by the motors. In a variable field motor, its magnetic flux is changed according to the number of revolutions per unit time (such as RPM). In general, there has been a demand for a variable field motor in which a high magnetic flux is generated when a large torque is required at a low rotation speed, and the magnetic flux is reduced when the motor is rotating at a high speed, so that the motor has high energy efficiency over a wide range from the low rotation speed to the high rotation speed.

Examples of methods for changing the amount of the magnetic flux in a variable field motor include a variable magnetic force method, a magnetic field coil method, and a winding switching method. For example, Japanese Patent No. 4965924 discloses a method for generating a variable field by combining an NdFeB magnet having high magnetization and a high coercive force with an alnico magnet having high magnetization and a low coercive force. However, there has been a problem that the coercive force of an alnico magnet is so small that the magnet cannot be easily used.

Meanwhile, as the variable magnetic force method, a method using a samarium cobalt magnet capable of changing the amount of the magnetic flux has been studied.

For example, International Patent Publication No. WO2009/145229 proposes the use of a samarium cobalt magnet as a magnet for a variable field. However, in the technique disclosed in International Patent Publication No. WO2009/145229, the value of the residual magnetization in a magnetic field of 10 kOe is 80% or higher, so it is not considered that the motor can satisfactorily perform a high-torque operation in which a strong magnetic flux is required.

### SUMMARY

In order to improve the efficiency of a variable field motor, it is desired that its permanent magnet reaches saturation magnetization in a low magnetic field when the permanent magnet is re-magnetized after being demagnetized, and there has been a demand for a permanent magnet having a high squareness ratio which is expressed as a ratio (Hk/Hcj) between a magnetic field (Hk) and a coercive force (Hcj).

The present disclosure has been made to solve the above-described problem, and an object thereof is to provide a rare-earth cobalt permanent magnet having a high residual magnetic flux density, a low coercive force, and a high squareness ratio, and to provide a method for manufacturing such a rare-earth cobalt permanent magnet and a device including such a rare-earth cobalt permanent magnet.

A first exemplary aspect is a rare-earth cobalt permanent magnet consisting of, when a rear-earth element including at least Sm is represented by R, 23 to 27 mass % of R, 1.0 to 5.0 mass % of Cu, 18 to 25 mass % of Fe, 1.5 to 3.0 mass % of Zr, and a remainder consisting of Co and unavoidable impurities, in which

the rare-earth cobalt permanent magnet includes a plurality of crystal grains and grain boundary parts, and

a concentration of Cu is at least two times a concentration of Zr in the grain boundary parts.

In an aspect of the rare-earth cobalt permanent magnet, a size of a cell structure constituting the crystal grain is 50 to 200 nm.

In an aspect of the rare-earth cobalt permanent magnet, saturation magnetization is equal to or larger than 1.16 T and an intrinsic coercive force Hcj is 120 to 800 kA/m.

In an aspect of the rare-earth cobalt permanent magnet, saturation magnetization is equal to or larger than 1.16 T and an intrinsic coercive force Hcj is 240 to 800 kA/m.

In an aspect of the rare-earth cobalt permanent magnet, a squareness ratio expressed as a ratio (Hk/Hcj) between a magnetic field Hk at 90% of residual magnetization and an intrinsic coercive force Hcj is equal to or higher than 60% in a demagnetization curve, and

when the rare-earth cobalt permanent magnet is re-magnetized from a demagnetizing field exceeding a knickpoint in the demagnetization curve, magnetization equal to or higher than 95% of the saturation magnetization is obtained in a magnetic field equal to or weaker than five times the intrinsic coercive force Hcj.

In an aspect of the rare-earth cobalt permanent magnet, a squareness ratio expressed as a ratio (Hk/Hcj) between a magnetic field Hk at 90% of residual magnetization and an intrinsic coercive force Hcj is equal to or higher than 60% in a demagnetization curve, and

when the rare-earth cobalt permanent magnet is re-magnetized from a demagnetizing field exceeding a knickpoint in the demagnetization curve, magnetization equal to or higher than 95% of the saturation magnetization is obtained in a magnetic field equal to or weaker than three times the intrinsic coercive force Hcj.

In an aspect of the rare-earth cobalt permanent magnet, when a diffraction intensity I(006) of a (006) plane and a diffraction intensity I(303) of a (303) plane are measured by a powder X-ray diffraction method, a diffraction intensity ratio I(006)/I (303) is 0.225 to 0.4.

A first method for manufacturing a rare-earth cobalt permanent magnet according to the present disclosure includes:

a step (I) of preparing an alloy consisting of, when a rear-earth element including at least Sm is represented by R, 23 to 27 mass % of R, 1.0 to 5.0 mass % of Cu, 18 to 25 mass % of Fe, 1.5 to 3.0 mass % of Zr, and a remainder consisting of Co and unavoidable impurities;

a pulverizing step (II) of pulverizing the alloy into a powder;

a pressure-molding step (III) of pressure-molding the powder into a molded body;

a step (IV) of sintering the molded body at 1,200 to 1,250° C.;

a step (V) of performing a solution treatment for the sintered molded body;

a step (VI) of heat-treating the molded body subjected to the solution treatment at 600 to 850° C.;

a step (VII) of cooling the molded body subjected to the heat treatment to 400° C. or lower at a rate of 0.2 to 10° C./min;

a step (VIII) of heat-treating the molded body at a temperature that is between 700 to 900° C. and higher than the temperature in the step (VI); and

a step (IX) of cooling the molded body subjected to the heat treatment to 400° C. or lower at a rate of 0.1 to 5° C./min.

A second method for manufacturing a rare-earth cobalt permanent magnet according to the present disclosure includes:

a step (I) of preparing an alloy consisting of, when a rear-earth element including at least Sm is represented by R, 23 to 27 mass % of R, 1.0 to 5.0 mass % of Cu, 18 to 25 mass % of Fe, 1.5 to 3.0 mass % of Zr, and a remainder consisting of Co and unavoidable impurities;

a pulverizing step (II) of pulverizing the alloy into a powder;

a pressure-molding step (III) of pressure-molding the powder into a molded body;

a step (IV) of sintering the molded body at 1,200 to 1,250° C.;

a step (V) of performing a solution treatment for the sintered molded body;

a step (VI-a) of heat-treating the molded body subjected to the solution treatment at 750 to 850° C.;

a step (VII-a) of cooling the molded body subjected to the heat treatment to 500 to 600° C. at a rate of 0.5 to 10° C./min, and then isothermally holding the molded body; and

a step (VIII-a) of rapidly cooling the molded body subjected to the isothermal holding.

Further, the present disclosure also provides a device including the above-described rare-earth cobalt permanent magnet.

According to the present disclosure, it is possible to provide a rare-earth cobalt permanent magnet having a high residual magnetic flux density, a low coercive force, and a high squareness ratio, and to provide a method for manufacturing such a rare-earth cobalt permanent magnet and a device including such a rare-earth cobalt permanent magnet.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF THE FIGURES

FIG. 1 is a schematic diagram for explaining a structure of a permanent magnet;

FIG. 2 is a graph showing a first quadrant and a second quadrant of a hysteresis curve of a permanent magnet according to an Example 1;

FIG. 3 shows dark-field scanning transmission electron microscope (DF-STEM) images of the permanent magnet according to the Example 1;

FIG. 4 is a graph showing results of analyses of compositions including grain boundary parts of the permanent magnet according to the Example 1; and

FIG. 5 shows powder X-ray diffraction spectrums of permanent magnets according to Examples 3 and 4 and a Reference Example 1.

### DETAILED DESCRIPTION

A rare-earth cobalt permanent magnet, a method for manufacturing a rare-earth cobalt permanent magnet, and a device according to the present disclosure will be described hereinafter in this order.

Note that a numerical range such as “n-m” or “n to m” (i.e., “from n to m”) includes the lower and upper limit values, unless otherwise specified.

### Rare-Earth Cobalt Permanent Magnet

A rare-earth cobalt permanent magnet according to the present disclosure (hereinafter also referred to as the permanent magnet according to the present disclosure or the like, or simply as the permanent magnet) consists of 23 to 27 mass % of a rear-earth element R including at least Sm, 1.0 to 5.0 mass % of Cu, 18 to 25 mass % of Fe, 1.5 to 3.0 mass % of Zr, and a remainder consisting of Co and unavoidable impurities, in which

the rare-earth cobalt permanent magnet includes a plurality of crystal grains and grain boundary parts, and

a concentration of Cu is at least two times a concentration of Zr in the grain boundary parts.

In general, it is believed that in a rare-earth cobalt permanent magnet having an Sm₂CO₁₇-phase type crystal phase (hereinafter also referred to as a “2-17 phase”), Cu increases a coercive force of the magnet, and Zr increases the amount of the solid solution of Fe and thereby indirectly increases a residual magnetic flux density Br of the magnet.

In the permanent magnet according to the present disclosure, by using either of two types of manufacturing methods described later, the concentration of Cu is adjusted to at least two times, preferably at least three times, the concentration of Zr in the grain boundary parts by controlling the diffusion of Cu and Zr. As a result, a permanent magnet having a high residual magnetic flux density, a low coercive force, and a high squareness ratio can be obtained.

Since the permanent magnet according to the present disclosure has magnetic characteristics suitable for variable field motors as described above, it is possible, by applying it to a variable field motor, to manufacture a variable field motor that is highly efficient over a wide range from a low speed to a high speed.

The rare-earth element R is a generic name of Sc, Y, and lanthanoids. Further, in the permanent magnet according to the present disclosure, the rare-earth element R includes at least Sm. By containing the rare-earth element(s) in the aforementioned ratio, it is possible to obtain a permanent magnet having high magnetic anisotropy. The rare-earth element R may consist of Sm alone, or may be a combination of Sm and other rare-earth elements. The other rare-earth element R is preferably at least one type of an element selected from Nd, Pr and Ce in view of the magnetic characteristic. In view of the magnetic characteristic, the rare-earth element R preferably contains Sm in 70 mass % or more, and more preferably 80 mass % or more based on the whole rare-earth element.

The rare-earth cobalt permanent magnet contains Cu in 1.0 to 5.0 mass %. By adjusting the content of Cu within this range, it is possible to obtain a high squareness ratio while adjusting the coercive force within an appropriate range.

The rare-earth cobalt permanent magnet contains Fe in 18 to 25 mass %. By adjusting the content of Fe within this range, it becomes easy to achieve a high residual magnetic flux density. Further, by containing 18 mass % or more of Fe, the saturation magnetization is improved. Further, by limiting the content of Fe to 25 mass % or less, the coercive force is adjusted to a value within an appropriate range.

Further, the rare-earth cobalt permanent magnet contains Zr in 1.5 to 3.0 mass %. By adjusting the content of Zr within this range, it becomes easy to indirectly increase the residual magnetic flux density Br by increasing the amount of the solid solution of Fe. Further, the maximum energy product (BH)max, which is a maximum magnetostatic energy that the magnet can hold, is improved.

Further, the remainder (i.e., 40 to 56.5 mass %) of the permanent magnet is consisting of Co and inevitable impurities.

By containing Co, the thermal stability of the permanent magnet is improved. On the other hand, when the content of Co is too large, the content of Fe is relatively lowered, thus raising a possibility that the magnetization may deteriorate. From these points, the content of Co is preferably 40 to 56.5 mass %.

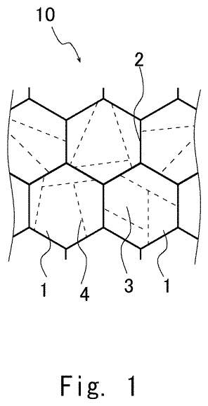

Next, a structure of the permanent magnet will be described with reference to FIG. 1. FIG. 1 is a schematic cross-sectional diagram showing a part of a cross section of the permanent magnet. As shown in the example shown in FIG. 1, the permanent magnet 10 includes a plurality of crystal grains 1 (areas surrounded by solid lines in the figure), and grain boundary parts 2 (solid lines in the figure) between the crystal grains 1. Each crystal grain 1 has cell phases 3 (areas surrounded only by dotted lines, or dotted lines and solid lines in the figure) containing a crystal phase having a Th₂Zn₁₇-type structure (hereinafter also referred to as a “2-17 phase”), and cell walls 4 (dotted lines in the figure) containing a crystal phase having an RCos-type structure (hereinafter also referred to as a “1-5 phase”) and surrounding the cell phases. In the present disclosure, the cell structure is a combination of one cell phase 3 and cell walls 4 surrounding this cell phase, and is a minimum unit constituting a crystal grain.

As described above, the permanent magnet has a cell phase having a crystal phase having a Th₂Zn₁₇-type structure as a main phase. The Th₂Zn₁₇-type structure is a crystal structure having an R-3m-type space group. In the permanent magnet according to the present disclosure, the Th part is occupied by a rare-earth element and Zr, and the Zn part is occupied by Co, Cu, Fe and Zr. Further, as described above, the permanent magnet has a cell wall including a crystal phase having an RCos-type structure. In the crystal phase having the RCos-type structure, the R part is occupied by the rare-earth element and Zr, and the Co part is occupied by Co, Cu and Fe. In the permanent magnet 10, the size of the cell structure means the length of the cell wall 4 (the length of the crystal phase of the RCos-type structure). In the permanent magnet according to the present disclosure, the cell size is preferably 50 to 200 nm in order to achieve a low coercive force.

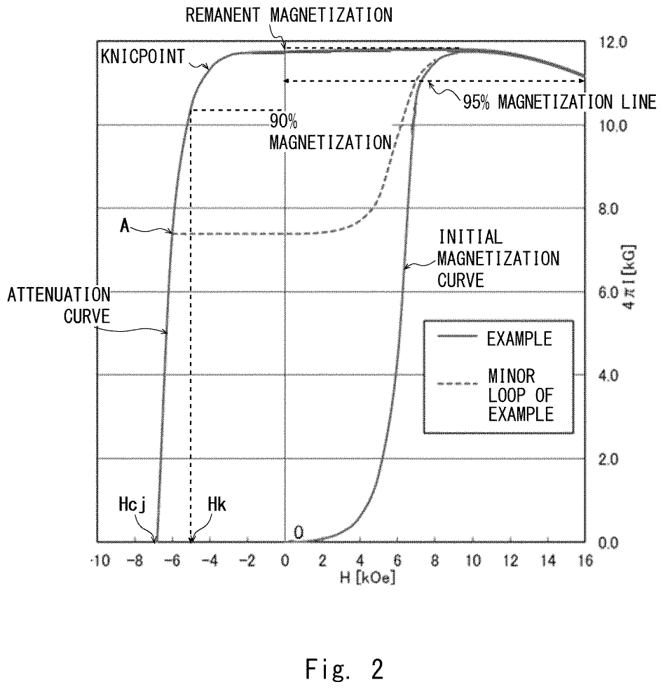

Next, characteristics of a permanent magnet according to the present disclosure will be described with reference to FIG. 2. FIG. 2 is a graph showing a first quadrant and a second quadrant (an attenuation curve) in a hysteresis curve of a permanent magnet according to an Example 1 (which will be described later). A vertical axis indicates magnetization (magnetic polarization), and a horizontal axis indicates strengths of the magnetic field. A positive value on the horizontal axis indicates the strength of a magnetic field applied in a direction in which the permanent magnet is magnetized, and a negative value indicates the strength of a magnetic field applied in a direction in which the permanent magnet is demagnetized.

When a magnetic field is applied to the permanent magnet in the positive direction, magnetic polarization occurs in accordance with an initial magnetization curve and it eventually reaches saturation magnetization. Next, when a magnetic field in the negative direction is applied to the permanent magnet, which is in the saturation magnetization state, the permanent magnet is rapidly demagnetized while passing through the knickpoint. The strength of the magnetic field at the point at which the magnetic polarization becomes zero is the intrinsic coercive force (Hcj).

In the present disclosure, the magnetic field at 90% of the residual magnetization is represented by Hk, and the ratio (Hk/Hcj) between the magnetic field Hk and the intrinsic coercive force Hci is defined as the squareness ratio. The permanent magnet according to the present disclosure can have a squareness ratio of 60% or higher, and preferably 70% or higher.

Further, in the permanent magnet according to the present disclosure, when it is re-magnetized from a demagnetizing field (a point A) exceeding the knickpoint in the demagnetization curve, magnetization equal to or higher than 95% of the saturation magnetization is obtained in a magnetic field equal to or weaker than five times (the absolute value of) the intrinsic coercive force Hcj, and preferably magnetization equal to or higher than 95% of the saturation magnetization is obtained in a magnetic field equal to or weaker than three times (the absolute value of) the intrinsic coercive force Hcj.

As described above, the permanent magnet according to the present disclosure has an excellent magnetization responsive property to the magnetic field, and can be suitably used even in a variable field motor of which the number of revolutions per unit time (such as RPM) frequently changes.

Further, the permanent magnet according to the present disclosure may have magnetic characteristics including, for example, saturation magnetization of 1.16 T or larger, and an intrinsic coercive force Hcj of 120 to 800 kA/m, preferably 200 to 800 kA/m, and more preferably 240 to 800 kA/m.

### Method for Manufacturing Rare-Earth Cobalt Permanent Magnet

The above-described rare-earth cobalt permanent magnet according to the present disclosure can be manufactured by using either of the below-shown two manufacturing methods. These two manufacturing methods will be described.

### First Manufacturing Method

A first method for manufacturing a rare-earth cobalt permanent magnet according to the present disclosure (hereinafter simply referred to as the first manufacturing method) includes:

a step (I) of preparing an alloy consisting of, when a rear-earth element including at least Sm is represented by R, 23 to 27 mass % of R, 1.0 to 5.0 mass % of Cu, 18 to 25 mass % of Fe, 1.5 to 3.0 mass % of Zr, and a remainder consisting of Co and unavoidable impurities;

a pulverizing step (II) of pulverizing the alloy into a powder;

a pressure-molding step (III) of pressure-molding the powder into a molded body;

a step (IV) of sintering the molded body at 1,200 to 1,250° C.;

a step (V) of performing a solution treatment for the sintered molded body;

a step (VI) of heat-treating the molded body subjected to the solution treatment at 600 to 850° C.;

a step (VII) of cooling the molded body subjected to the heat treatment to 400° C. or lower at a rate of 0.2 to 10° C./min;

a step (VIII) of heat-treating the molded body at a temperature that is between 700 to 900° C. and higher than the temperature in the step (VI); and

a step (IX) of cooling the molded body subjected to the heat treatment to 400° C. or lower at a rate of 0.1 to 5° C./min.

According to the above-described first manufacturing method, it is possible to manufacture a rare-earth cobalt permanent magnet including a plurality of crystal grains and grain boundary parts, in which the concentration of Cu is at least two times the concentration of Zr in the grain boundary parts.

According to the first manufacturing method, it is possible to suitably manufacture a rare-earth cobalt permanent magnet having a cell size of 50 to 200 nm.

According to the first manufacturing method, it is possible to suitably manufacture a rare-earth cobalt permanent magnet having saturation magnetization equal to or larger than 1.16 T and an intrinsic coercive force Hcj of 240 to 800 kA/m.

According to the first manufacturing method, it is possible to suitably manufacture a rare-earth cobalt permanent magnet in which a squareness ratio expressed as a ratio (Hk/Hcj) between a magnetic field Hk at 90% of residual magnetization and an intrinsic coercive force Hcj is equal to or higher than 60% in a demagnetization curve, and when the rare-earth cobalt permanent magnet is re-magnetized from a demagnetizing field exceeding a knickpoint in the demagnetization curve, magnetization equal to or higher than 95% of the saturation magnetization is obtained in a magnetic field equal to or weaker than three times the intrinsic coercive force Hcj.

Further, according to the first manufacturing method, it is possible to suitably manufacture a rare-earth cobalt permanent magnet in which when a diffraction intensity I(006) of a (006) plane and a diffraction intensity I(303) of a (303) plane are measured by a powder X-ray diffraction method, a diffraction intensity ratio I(006)/I (303) is 0.225 to 0.4.

In the first manufacturing method, the above-described steps (I) to (IX) are typically carried out in the above-described order. Further, the first manufacturing method may further include other steps as long as the advantageous effects of the present disclosure are not impaired. Each of the steps will be described hereinafter.

Firstly, an alloy consisting of, when a rear-earth element including at least Sm is represented by R, 23 to 27 mass % of R, 1.0 to 5.0 mass % of Cu, 18 to 25 mass % of Fe, 1.5 to 3.0 mass % of Zr, and a remainder consisting of Co and unavoidable impurities is prepared (step (I)). The method for preparing the alloy is not limited to any particular method. For example, the alloy may be prepared by obtaining a commercially-available alloy having a desired composition, or by blending the aforementioned elements so that a desired composition is obtained.

A specific example of the blending of the elements will be described hereinafter, but the manufacturing method according to the present disclosure is not limited to this example method.

Firstly, a desired rare-earth element(s), each of metal elements of Fe, Cu and Co, and a base alloy are prepared as ingredients. Note that it is preferable to select, as the base alloy, one having a composition having a low eutectic temperature because, by doing so, it is easy to make the composition of the obtained alloy uniform. In this manufacturing method, FeZr or CuZr is preferably selected and used as the base alloy. As an example of FeZr, one containing about 20% of Fe and about 80% of Zn is suitable. Further, as an example of CuZr, one containing about 50% of Cu and 50% of Zr is suitable.

It is possible to obtain a homogeneous alloy by blending the aforementioned ingredients so as to have a desired composition, putting the blend in a crucible made of alumina or the like, and dissolving the blend in a vacuum of 1×10⁻² torr or lower, or in an inert-gas atmosphere by using a high-frequency melting furnace. Further, the manufacturing method according to the present disclosure may include a step of casting the molten alloy by using a mold and thereby obtaining an alloy ingot. Alternatively, as a different method, a flaky alloy having a thickness of about 1 mm may be manufactured by dropping the molten alloy onto a copper roll (a strip casting method). In the present disclosure, a melting method using a melting furnace is preferred because, by using such a melting method, a permanent magnet having a high residual magnetic flux density and a high squareness ratio is easily obtained.

In the case of forming an alloy ingot by the above-described casting, the manufacturing method preferably includes, before the step (II) (which will be described later), a step of heat-treating the alloy ingot at a solution-treatment temperature for no shorter than one hour and no longer than 20 hours. It is possible, by this step, to make the composition more uniform. Note that the solution-treatment temperature for the alloy ingot may be adjusted as appropriate according to the composition and the like of the alloy.

Next, the alloy is pulverized into a powder (step (II)). The method for pulverizing the alloy is not limited to any particular method, and may be selected as appropriate from known methods. As an example, the alloy ingot or the flake alloy is first coarsely pulverized to a size of about 100 to 500 μm by a known pulverizing machine, and then finely pulverized by a ball mill or a jet mill. Although the average particle diameter of the powder is not limited to any particular value, the alloy ingot or the flake alloy may be pulverized to a powder having an average particle diameter of no smaller than 1 μm and no larger than 10 μm, and preferably about 6 μm so that the sintering time of the sintering step (which will be described later) can be shortened and a homogeneous permanent magnet can be manufactured.

Next, the obtained powder is pressure-molded, so that a molded body having a desired shape is obtained (step (III)). In the manufacturing method according to the present disclosure, the obtained powder is preferably pressure-molded in a constant magnetic field in order to align the orientation of crystals and thereby to improve the magnetic characteristic. There is no particular restriction on the relation between the direction of the magnetic field and the pressing direction, and the relation may be selected as appropriate according to the shape and the like of the product. For example, when a ring magnet or a thin plate-like magnet is manufactured, it is possible to use parallel magnetic-field pressing in which a magnetic field is applied in a direction parallel to the pressing direction. On the other hand, in order to achieve excellent magnetic characteristics, it is preferable to use right-angle magnetic-field pressing in which a magnetic field is applied at a right angle with respect to the pressing direction.

The magnitude of the magnetic field is not limited to any particular value, and the magnetic field may be, for example, a magnetic field of 15 kOe or weaker, or a magnetic field of 15 kOe or larger depending on the use and the like of the product. However, in order to achieve excellent magnetic characteristics, it is preferable to perform the pressure-molding in a magnetic field of 15 kOe or larger. Further, the pressure in the pressure molding may be adjusted as appropriate according to the size, the shape, and the like of the product. As an example, the pressure may be 0.5 to 2.0 ton/cm². That is, in the manufacturing method according to the present disclosure, in order to achieve excellent magnetic characteristics, it is particularly preferable that the powder is press-molded in a magnetic field of 15 kOe or larger while applying a pressure of no lower than 0.5 ton/cm² and no higher than 2.0 ton/cm² perpendicularly to the magnetic field.

Next, the molded body is heated, so that a sintered body is obtained (step (IV)). In this manufacturing method according to the present disclosure, the conditions for the sintering can be arbitrarily determined as long as the obtained sintered body is sufficiently densified. For example, known conditions may be used. In order to densify the sintered body, the sintering temperature is preferably 1,200 to 1,250° C. By adjusting the temperature to 1,250° C. or lower, the rare-earth elements, particularly Sm, are prevented from evaporating, and hence a permanent magnet having excellent magnetic characteristics can be manufactured.

Regarding the condition for the temperature rise in the sintering step, in order to remove an adsorption gas contained in the molded body, vacuuming is preferably started first at a room temperature and then the temperature is preferably raised at a rate of 1 to 10° C./min. In the above-described temperature raising process, a hydrogen atmosphere may be used instead of performing the vacuuming. In such a case, the atmosphere is preferably changed to a vacuum atmosphere at a temperature equal to or lower than 1,150° C.

The sintering time is preferably 20 to 240 minutes, and more preferably 30 to 180 minutes in order to sufficiently densify the sintered body while preventing Sm from evaporating. Further, in order to prevent the oxidation, the above-described sintering step is preferably performed in a vacuum or an inert-gas atmosphere of 1×10⁻² Torr or lower, and more preferably in a vacuum of 1×10⁻⁴ Torr or lower.

Next, the obtained sintered body is gradually cooled at a temperature decreasing rate of 0.2 to 5° C./min. Next, a solution treatment is performed for the gradually-cooled sintered body (step (V)). The temperature of the solution-treatment may be adjusted as appropriate according to the sintered body and desired magnet characteristics, and the solution treatment is preferably performed at a temperature 20 to 50° C. lower than the sintering temperature. The time of the solution treatment may be adjusted as appropriate within a range of, for example, 2 to 20 hours.

After the solution treatment, the sintered body is preferably rapidly cooled to 400° C. or lower.

Next, the sintered body is heat-treated at 600 to 850° C. (step (VI)). The time of the heat treatment may be adjusted as appropriate according to desired magnet characteristics, and is preferably, for example, 0.5 to 3 hours. The molded body, which has been subjected to the heat treatment, is cooled to 400° C. or lower at a rate of 0.2 to 10° C./min (step (VII)). Next, the molded body is heat-treated at a temperature that is between 700 to 900° C. and higher than the temperature in the step (VI) (step (VIII)). The time of the heat treatment may be, for example, 0.5 to 10 hours. Next, the molded body, which has been subjected to the heat treatment, is cooled to 400° C. or lower at a rate of 0.1 to 5° C./min (step (IX)), so that a permanent magnet according to the present disclosure is obtained.

In the first manufacturing method, it is inferred that cell structures are formed in crystal grains during the isothermal holding in the steps (VI and VIII). However, it is inferred that the concentration of Cu in the crystal grains is low at this stage and Cu is concentrated in the crystal grain boundaries. Meanwhile, it is inferred that Zr is solid-dissolved in the crystal grains, so that it forms a 2-17 phase containing a large amount of Fe. In the first manufacturing method, through the two heat treatments (step (VI) to step (IX)), cell structures having cell walls of 50 to 200 nm are formed in the crystal grains, and Cu and Zr are moderately diffused. As a result, the concentration of Cu becomes at least two times, preferably at least three times, the concentration of Zr in the grain boundary parts.

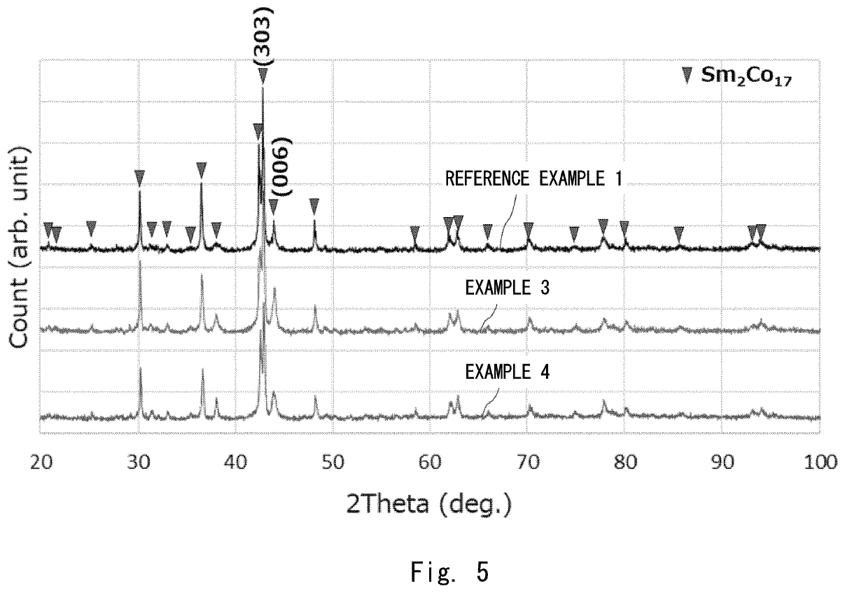

Further, according to the first manufacturing method, it is possible to suitably manufacture a rare-earth cobalt permanent magnet in which when a diffraction intensity I(006) of a (006) plane and a diffraction intensity I(303) of a (303) plane are measured by a powder X-ray diffraction method, a diffraction intensity ratio I(006)/I (303) is 0.225 to 0.4. FIG. 5 shows powder X-ray diffraction spectrums of permanent magnets according to Examples 3 and 4 and a Reference Example 1. It is shown that in the permanent magnet obtained by the first manufacturing method, the peak intensity of the (006) plane, which is the axis of easy magnetization (the C-axis), becomes higher. As described above, according to the first manufacturing method, the degree of the orientation (i.e., the alignment) of the C-axis is improved, and as a result, the magnetization property is improved.

### Second Manufacturing Method

A second method for manufacturing a rare-earth cobalt permanent magnet according to the present disclosure (hereinafter simply referred to as the second manufacturing method) includes:

a step (I) of preparing an alloy consisting of, when a rear-earth element including at least Sm is represented by R, 23 to 27 mass % of R, 1.0 to 5.0 mass % of Cu, 18 to 25 mass % of Fe, 1.5 to 3.0 mass % of Zr, and a remainder consisting of Co and unavoidable impurities;

a pulverizing step (II) of pulverizing the alloy into a powder;

a pressure-molding step (III) of pressure-molding the powder into a molded body;

a step (IV) of sintering the molded body at 1,200 to 1,250° C.;

a step (V) of performing a solution treatment for the sintered molded body;

a step (VI-a) of heat-treating the molded body subjected to the solution treatment at 750 to 850° C.;

a step (VII-a) of cooling the molded body subjected to the heat treatment to 500 to 600° C. at a rate of 0.5 to 10° C./min, and then isothermally holding the molded body; and

a step (VIII-a) of rapidly cooling the molded body subjected to the isothermal holding.

According to the above-described second manufacturing method, it is possible to manufacture a rare-earth cobalt permanent magnet including a plurality of crystal grains and grain boundary parts, in which the concentration of Cu is at least two times the concentration of Zr in the grain boundary parts.

According to the second manufacturing method, it is possible to suitably manufacture a rare-earth cobalt permanent magnet having a cell size of 50 to 200 nm.

According to the second manufacturing method, it is possible to suitably manufacture a rare-earth cobalt permanent magnet having saturation magnetization equal to or larger than 1.16 T and an intrinsic coercive force Hcj of 120 to 800 kA/m.

Further, according to the second manufacturing method, it is possible to suitably manufacture a rare-earth cobalt permanent magnet in which a squareness ratio expressed as a ratio (Hk/Hcj) between a magnetic field Hk at 90% of residual magnetization and an intrinsic coercive force Hcj is equal to or higher than 60% in a demagnetization curve, and when the rare-earth cobalt permanent magnet is re-magnetized from a demagnetizing field exceeding a knickpoint in the demagnetization curve, magnetization equal to or higher than 95% of the saturation magnetization is obtained in a magnetic field equal to or weaker than five times the intrinsic coercive force Hcj.

In the second manufacturing method, the above-described steps (I) to (VIII-a) are typically carried out in the above-described order. Further, the second manufacturing method may further include other steps as long as the advantageous effects of the present disclosure are not impaired.

Note that, in the second manufacturing method, the steps (I) to (V) are similar to those in the first manufacturing method, and the preferred manufacturing conditions are also the same as those for the first manufacturing method, so that the redundant descriptions thereof are omitted.

After the solution treatment (step (V)), the molded body is preferably rapidly cooled to 400° C. or lower.

Next, the sintered body is heat-treated at 750 to 850° C. (step (VI-a)). The time of the heat treatment may be adjusted as appropriate according to desired magnet characteristics, and is preferably, for example, 0.5 to 10 hours. Through this step, cell structures having cell walls of 50 to 200 nm are formed in the crystal grains, and Cu and Zr are moderately diffused. As a result, the concentration of Cu becomes at least two times, preferably at least three times, the concentration of Zr in the grain boundary parts.

The molded body, which has been subjected to the heat treatment, is cooled to 500 to 600° C. at a rate of 0.5 to 10° C./min, and then isothermally held (i.e., isothermally left undisturbed) (step (VII-a)). The time of the isothermal holding may be adjusted as appropriate within a range of, for example, 0.5 to 10 hours. By rapidly cooling the modeled body subjected to the isothermal holding (step (VIII-a)), a permanent magnet according to the present disclosure is obtained.

In the second manufacturing method, it is inferred that cell structures are formed in crystal grains during the isothermal holding in the steps (VI-a). However, it is inferred that the concentration of Cu in the crystal grains is low at this stage and Cu is concentrated in the crystal grain boundaries. Meanwhile, it is inferred that Zr is solid-dissolved in the crystal grains, so that it forms a 2-17 phase containing a large amount of Fe. It is inferred that as the process proceeds from the isothermal holding in the step (VI-a) to the gradual cooling, Cu and Zr diffuse into each other, and Cu concentrates in the cell walls constituting the cell structures in the crystal grains, so that the coercive force increases.

### Device

The present disclosure further provides a device including the above-described permanent magnet. Examples of such a device include clocks (watches), electric motors, various instruments, communication apparatuses, computer terminals, speakers, video discs, and sensors. The rare-earth cobalt permanent magnet according to the present disclosure has a high residual magnetic flux density, a low coercive force, and a high squareness ratio as described above. Therefore, the permanent magnet can be suitably used, in particular, for a variable field motor, and hence it is possible to obtain a variable field motor that is highly efficient over a wide range from a low speed to a high speed.

### EXAMPLE

The present disclosure will be described hereinafter in a concrete manner with reference to examples and comparative examples. Note that the present disclosure is not limited by the descriptions of examples below.

### Example 1: Second Manufacturing Method

An alloy ingot having a composition of 25.0 mass % of Sm, 4.0 mass % of Cu, 21.0 mass % of Fe, 2.2 mass % of Zr and a remainder Co was obtained by melting a base alloy containing 20 mass % of Fe and 80 mass % of Zr, and ingredients including various elements in a vacuum of 1×10⁻² Torr or lower by using a high-frequency melting furnace.

Next, after the obtained alloy ingot was heat-treated at 1,170° C. for 15 hours, the heat-treated alloy ingot was coarsely pulverized, and then finely-pulverized into a powder so that the average diameter became about 6 μm in an inert-gas atmosphere by using a jet mill. Next, by pressing the powder with a pressure of 1.0 ton/cm² in a magnetic field of 15 kOe, a molded body having a length 100 mm, a width of 50 mm, and a height of 50 mm was molded by using dies.

The obtained molded body was sintered at a temperature of 1,200° C. in a vacuum of 1×10⁻² Torr or lower. Next, the sintered molded body was cooled to 1,170° C. at a rate of 1° C./min, held for four hours, and subjected to a solution treatment. Immediately after that, the sintered body was rapidly cooled at a cooling rate of 100° C./min.

An isothermal aging treatment was performed for the sintered body, which has been rapidly cooled, by heating it to and holding it at a temperature of 800° C. for one hour in an inert-gas atmosphere. After that, the sintered body was continuously and gradually cooled to 550° C. or lower at a cooling rate of 2° C./min, held at 550° C. for five hours, and then rapidly cooled, so that a permanent magnet according to the Example 1 was obtained.

### Example 2: Second Manufacturing Method

A permanent magnet according to an Example 2 was obtained in the same manner as in the Example 1, except that the time of the heating and holding at the temperature of 800° C. in the isothermal aging treatment was changed to five hours.

### Comparative Example 1

A permanent magnet according to a Comparative Example 1 was obtained in the same manner as in the Example 1, except that the time of the heating and holding at the temperature of 850° C. in the isothermal aging treatment was changed to ten hours, and the temperature was lowered to 350° C. or lower at a cooling rate of 0.25° C./min in the subsequent continuous and gradual cooling.

### Evaluation

As measurement samples, permanent magnet pieces that were obtained by processing (e.g., cutting) the permanent magnets according to the Examples 1 and 2 and the Comparative Example 1, respectively, into pieces each of which has a shape of 10×10×7 mm were prepared. The thickness of 7 mm is in the direction of the orientation (i.e., the alignment) of the magnetic field (C-axis orientation).

A hysteresis curve of the Example 1 will be described with reference to FIG. 2. The measurement for this hysteresis curve was performed by a method in which a measurement sample was interposed between pole pieces of an electromagnet called a DC (Direct-Current) magnetization characteristic analyzer. Further, although it was unnecessary to perform any correction for the demagnetizing field, the apparent magnetization was lowered in a magnetic field exceeding 10 kOe in the first quadrant due to the so-called mirror-image effect. However, in practice, the magnetization curve becomes such a curve that the permanent magnet is magnetized to the saturation magnetization. As shown in FIG. 2, it can be understood that, in the Example 1, the rise of the initial magnetization curve is steep and it reaches the saturation magnetization in a low magnetic field of about 10 kOe. A result of the measurement of a minor loop is also shown (by a dotted line). In the Example 1, it was shown that the magnetization curve coincided with the initial magnetization curve in a range of 8 to 10 kOe. Further, when their magnetic susceptibilities were compared at 10 kOe, they almost completely coincided with each other. Similar measurements were carried out for the Example 2 and the Comparative Example 1. Table 1 shows the results of the measurements.

Further, the Table 1 also shows results of measurements of residual magnetic flux densities.

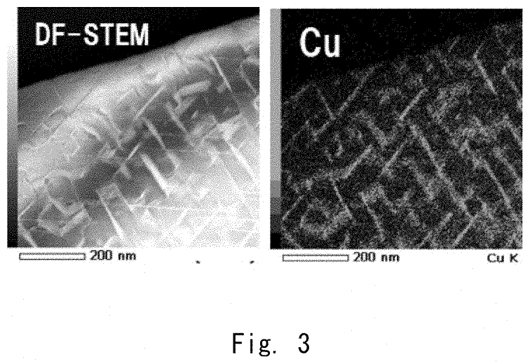

Next, FIG. 3 shows a DF-STEM (Dark-Field Scanning Transmission Electron Microscope) image of the Example 1. In FIG. 3, the image on the left side is the DF-STEM image and that on the right side is a Cu composition image in which Cu is extracted. Characteristic cell structures that are formed by the heat treatment of the Sm₂Co₁₇ alloy are seen. The inside of the cell is a 2-17 crystal phase composed of a ferromagnetic phase, and the cell wall between cells is a 1-5 crystal phase containing non-magnetic Cu. Therefore, it is possible to measure the size of the cell from the Cu composition image. It can be seen that the cell size of the alloy, which was measured by the above-described method, was 50 to 200 nm.

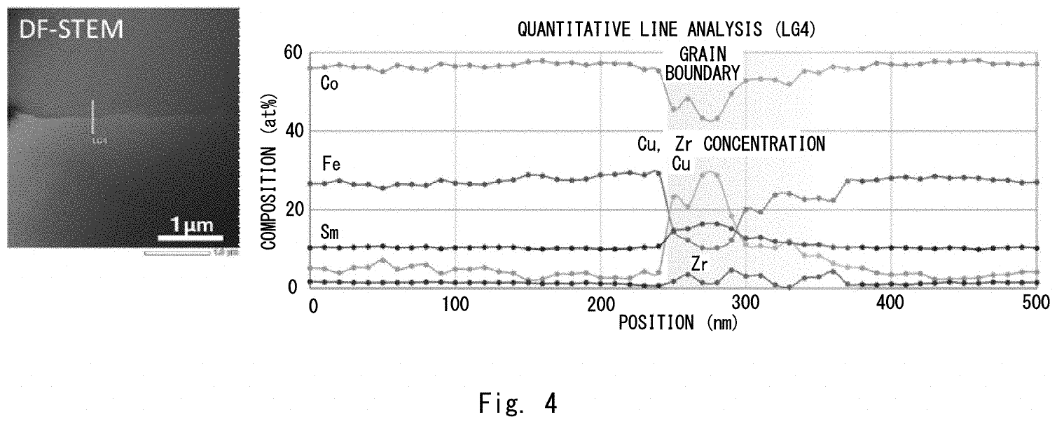

Further, FIG. 4 shows results of analyses of compositions in which grain boundary phases that are present between crystal grains were observed. The “Position” in the graph shown in FIG. 4 indicates distances from the upper end of a straight line LG4 to measurement points in the DF-STEM image shown on the left side of FIG. 4 in which the upper end is defined as zero (i.e., as the origin). As shown in FIG. 4, it can be seen that Cu and Zr are concentrated in the grain boundary phases. The Table 1 shows ratios between Cu and Zr. It can be seen that the ratio of Cu is higher than that of Zr in the Example 1.

TABLE 1

| | | | Residual | Intrinsic | Squareness | |
|---|---|---|---|---|---|---|
| | Grain | | magnetic | coercive | ratio | Magnetic |
| | boundary | Cell size | flux density | force | (Hk/Hcj) | susceptibility |
| | parts Cu/Zr | [nm] | [kG] | [kOe] | [%] | [%] |
| Example 1 | 5.1 | 50-200 | 11.81 | 3.4 | 72 | 99.6 |
| Example 2 | 2.8 | 100-200 | 11.69 | 6.2 | 63 | 97.0 |
| Comparative | 1.5 | 100-300 | 11.61 | 22-23 | 75 | 19.5 |
| Example 1 | | | | | | |

### Example 3: First Manufacturing Method

A molded body of an alloy ingot having a composition of 21.55 mass % of Fe, 25.65 mass % of Sm, 4.5 mass % of Cu, 2.20 mass % of Zr and a remainder Co was obtained in the same manner as in the Example 1, except for the amounts of added raw materials.

The obtained molded body was sintered at a temperature of 1,210° C. for one hour in a vacuum of 1×10⁻² Torr or lower. Next, the sintered body was subjected to a solution treatment at 1,155° C. for 15 hours, and immediately after that, the sintered body was rapidly cooled at a cooling rate of 100° C./min. An isothermal aging treatment was performed for the sintered body, which has been rapidly cooled, by heating it to and holding it at a temperature of 750° C. for two hours in an inert-gas atmosphere. After that, the sintered body was gradually cooled to 400° C. or lower at a cooling rate of 2° C./min. Further, an isothermal aging treatment was performed for the sintered body by heating it to and holding it at a temperature of 765° C. for 5.5 hours in an inert-gas atmosphere. After that, the sintered body was continuously and gradually cooled to 700° C. at a cooling rate of 0.5° C./min, to 500° C. at a cooling rate of 0.25° C./min, and to 400° C. or lower at a cooling rate of 0.5° C./min, so that a permanent magnet according to an Example 3 was obtained.

### Example 4: Second Manufacturing Method

A molded body of an ingot was obtained in the same manner as in the Example 3, and the obtained molded body was sintered, subjected to a solution treatment, and rapidly cooled. An isothermal aging treatment was performed for the sintered body, which has been rapidly cooled, by heating it to and holding it at a temperature of 815° C. for 5.5 hours in an inert-gas atmosphere. After that, the sintered body was continuously and gradually cooled to 550° C. at a cooling rate of 2° C./min, held at 550° C. for five hours, and then rapidly cooled, so that a permanent magnet according to an Example 4 was obtained.

### Reference Example 1

A permanent magnet according to a Reference Example 1 was obtained in the same manner as in the Example 3, except that the step for the aging treatment at 750° C. and the subsequent steps were not carried out.

### Evaluation

The Examples 3 and 4 were evaluated in the same manner as in the Examples 1 and 2. Table 2 shows results.

Further, FIG. 5 shows spectrums of permanent magnets according to the Examples 3 and 4 and the Reference Example 1 measured by a powder X-ray diffraction method. Note that marks are added to peaks related to Sm₂Co₁₇ of the Reference Example 1. A diffraction intensity ratio I(006)/I (303) between a diffraction intensity I(006) of a (006) plane and a diffraction intensity I(303) of a (303) plane was 0.138 in the Reference Example 1, was 0.270 in the Example 3, and was 0.197 in the Example 4. It is shown that in the permanent magnet obtained by the first manufacturing method such as the one in the Example 3, the peak intensity of the (006) plane, which is the axis of easy magnetization (the C-axis), became higher. As described above, according to the first manufacturing method, the degree of the orientation (i.e., the alignment) of the C-axis is improved, and as a result, the magnetization property is improved.

TABLE 2

| | | | Residual | Intrinsic | Squareness | |
|---|---|---|---|---|---|---|
| | Grain | | magnetic | coercive | ratio | Magnetic |
| | boundary | Cell size | flux density | force | (Hk/Hcj) | susceptibility |
| | parts Cu/Zr | [nm] | [kG] | [kOe] | [%] | [%] |
| Example 3 | 3.5 | 50-100 | 11.97 | 4.1 | 71 | 98.4 |
| Example 4 | 5.0 | 100-200 | 11.81 | 4.1 | 60 | 97.8 |

* Magnetic susceptibility: Measured in applied magnetic field of 10 kOe

As described above, it has been found that a rare-earth cobalt permanent magnet according to the present disclosure consisting of 23 to 27 mass % of a rear-earth element R, 1.0 to 5.0 mass % of Cu, 18 to 25 mass % of Fe, 1.5 to 3.0 mass % of Zr, and a remainder consisting of Co and unavoidable impurities, in which the rare-earth cobalt permanent magnet includes a plurality of crystal grains and grain boundary parts, and the concentration of Cu is at least two times the concentration of Zr in the grain boundary parts has a high residual magnetic flux density, a low coercive force, and a high squareness ratio, and has magnetic characteristics suitable for variable field motors.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion equal to or smaller than the scope of the following claims.

1. A rare-earth cobalt permanent magnet consisting of, when a rear-earth element including at least Sm is represented by R, 23 to 27 mass % of R, 1.0 to 5.0 mass % of Cu, 18 to 25 mass % of Fe, 1.5 to 3.0 mass % of Zr, and a remainder consisting of Co and unavoidable impurities, in which
the rare-earth cobalt permanent magnet includes a plurality of crystal grains and grain boundary parts, and
a concentration of Cu is at least two times a concentration of Zr in the grain boundary parts.

2. The rare-earth cobalt permanent magnet according to claim 1, wherein a size of a cell structure constituting a crystal grain is 50 to 200 nm.

3. The rare-earth cobalt permanent magnet according to claim 1, wherein a saturation magnetization is equal to or larger than 1.16 T and an intrinsic coercive force Hcj is 120 to 800 kA/m.

4. The rare-earth cobalt permanent magnet according to claim 1, wherein saturation magnetization is equal to or larger than 1.16 T and an intrinsic coercive force Hcj is 240 to 800 kA/m.

5. The rare-earth cobalt permanent magnet according to claim 1, wherein a squareness ratio expressed as a ratio (Hk/Hcj) between a magnetic field Hk at 90% of residual magnetization and an intrinsic coercive force Hcj is equal to or higher than 60% in a demagnetization curve, and
when the rare-earth cobalt permanent magnet is re-magnetized from a demagnetizing field exceeding a knickpoint in the demagnetization curve, magnetization equal to or higher than 95% of the saturation magnetization is obtained in a magnetic field equal to or weaker than five times the intrinsic coercive force Hcj.

6. The rare-earth cobalt permanent magnet according to claim 1, wherein a squareness ratio expressed as a ratio (Hk/Hcj) between a magnetic field Hk at 90% of residual magnetization and an intrinsic coercive force Hcj is equal to or higher than 60% in a demagnetization curve, and
when the rare-earth cobalt permanent magnet is re-magnetized from a demagnetizing field exceeding a knickpoint in the demagnetization curve, magnetization equal to or higher than 95% of the saturation magnetization is obtained in a magnetic field equal to or weaker than three times the intrinsic coercive force Hcj.

7. The rare-earth cobalt permanent magnet according to claim 1, wherein when a diffraction intensity I(006) of a plane and a diffraction intensity I of a plane are measured by a powder X-ray diffraction method, a diffraction intensity ratio I(006)/I (303) is 0.225 to 0.4.

8. A method for manufacturing a rare-earth cobalt permanent magnet, comprising:
a step (I) of preparing an alloy consisting of, when a rear-earth element including at least Sm is represented by R, 23 to 27 mass % of R, 1.0 to 5.0 mass % of Cu, 18 to 25 mass % of Fe, 1.5 to 3.0 mass % of Zr, and a remainder consisting of Co and unavoidable impurities;
a pulverizing step (II) of pulverizing the alloy into a powder;
a pressure-molding step (III) of pressure-molding the powder into a molded body;
a step (IV) of sintering the molded body at 1,200 to 1,250° C.;
a step (V) of performing a solution treatment for a sintered molded body;
a step (VI) of heat-treating the molded body subjected to the solution treatment at 600 to 850° C.;
a step (VII) of cooling the molded body subjected to a heat treatment to 400° C. or lower at a rate of 0.2 to 10° C./min;
a step (VIII) of heat-treating the molded body at a temperature that is between 700 to 900° C. and higher than the temperature in the step (VI); and
a step (IX) of cooling the molded body subjected to the heat treatment to 400° C. or lower at a rate of 0.1 to 5° C./min.

9. A method for manufacturing a rare-earth cobalt permanent magnet, comprising:
a step (I) of preparing an alloy consisting of, when a rear-earth element including at least Sm is represented by R, 23 to 27 mass % of R, 1.0 to 5.0 mass % of Cu, 18 to 25 mass % of Fe, 1.5 to 3.0 mass % of Zr, and a remainder consisting of Co and unavoidable impurities;
a pulverizing step (II) of pulverizing the alloy into a powder;
a pressure-molding step (III) of pressure-molding the powder into a molded body;
a step (IV) of sintering the molded body at 1,200 to 1,250° C.;
a step (V) of performing a solution treatment for the sintered molded body;
a step (VI) of heat-treating the molded body subjected to the solution treatment at 750 to 850° C.;
a step (VII) of cooling the molded body subjected to the heat treatment to 500 to 600° C. at a rate of 0.5 to 10° C./min, and then isothermally holding the molded body; and
a step (VIII) of rapidly cooling the molded body subjected to the isothermal holding.

10. A device comprising a rare-earth cobalt permanent magnet according to claim 1.
